(19) United States
(12) Patent Application Publication
(10) Pub. No.: US 2022/0176724 A1
(43) Pub. Date: Jun. 9, 2022

(54) BLANKET OR SLAB FOR OVERPRINT VARNISHING

(71) Applicant: Levi Acobas Roberto, Milano (IT)

(72) Inventor: Levi Acobas Roberto, Milano (IT)

(21) Appl. No.: 17/112,311

(22) Filed: Dec. 4, 2020

(51) Int. Cl. B41M 7/00

(52) U.S. Cl. CPC B41M 7/0027

(57) ABSTRACT

A blanket or slab for overprint varnishing at least including a varnishing layer and a single-layer or multilayer support of uniform thickness. The varnishing layer can be made of a non-cross-linked elastomeric thermoplastic polymer, and have non-image areas where no transfer of varnish takes place. The non-image areas can be areas of the varnishing layer that lack material and extend from the outer surface of the varnishing layer to a depth which is no less than half the thickness of the varnishing layer. At least one non-image area can delineate a geometric shape having an area of less than 5 mm². The varnishing layer having non-image areas can be a physical reproduction of a digital model obtained with additive technology.

### FIELD OF USE

The invention relates to a blanket or slab for overprint varnishing.

### BACKGROUND OF THE INVENTION

In the context of offset printing specific processes exist that allow the printed item to have special finishes or protections.

One of these processes is the application of overprint varnishes.

These varnishes are typically UV cross-linking or water-based acrylic; they are usually applied using one or more special printing units (known as “varnishing units”) positioned as final elements of the machine and followed, if necessary, by ovens or lamps for the drying or cross-linking of the varnishes themselves.

The transfer of the varnish onto the support takes place using a rubber-coated fabric (blanket) or a varnishing slab that has the function of collecting the varnish and transferring it to the support for printing. If it is necessary to preserve some zones of this application, in common practice the upper layer of the blanket or of the slab is cut and removed in the aforementioned zones so that the difference in thickness allows the transfer of the varnish to be prevented. These areas of lack of material with a lower thickness notched in the blankets or in the slab are known as “reserves”.

The reserves are normally performed by notching the varnishing layer which is then manually removed. The notching itself can be performed with a manual operation but it more commonly takes place through the aid of a cutting plotter.

Considering the manual removal of the varnishing layer and the use of blades for notching, in general the geometries that can be processed must be simple and of relatively large dimensions as there may be precision issues for more complicated geometries. These technical barriers enormously limit the possibilities of customising the printed items.

In the case of complex non-image areas, in current common techniques, special slabs have normally been used that require a complex and expensive preparation.

In fact, these slabs are generally constructed using expensive photopolymers and normally undergo a complex preparation in three steps which, although automated, requires dedicated and expensive machinery.

In most cases printers contact external facilities that offer this preparation service.

In particular, in a first step a special protective film is removed by laser ablation which leaves the photopolymer uncovered in the zones of the graphics, in a second step the slab is exposed to a lamp (generally UV) which solidifies the unprotected parts of the film and finally a third step, known as development, in which the non-cross-linked photopolymer is eliminated by washing with water or with solvent.

In very recent years a direct laser ablation technique for non-image areas has been developed, however also in this case the machines are expensive and complex, the process is normally performed externally by specialised facilities and it is mainly used for the preparation of sleeves, not being very economically advantageous for slabs.

An alternative approach is represented by additive manufacturing techniques, which allows the blankets or slabs to be manufactured directly in the desired shapes, therefore avoiding the steps of notching and removing the reserves and limiting the waste of material connected therewith. In particular, 3D printing has developed exceptionally over the last decade, thanks to its versatility of use for prototyping and producing three-dimensional objects in a wide variety of materials. However, materials are commonly used that are not very suitable for printing and varnishing, in particular in terms of properties of the transfer of varnishes or inks, chemical resistance to UV varnishes or to slab washing solvents for UV varnishing, and mechanical resistance to impact and to abrasion.

The task of the present invention is therefore to eliminate the above-mentioned drawbacks of the prior art.

### SUMMARY OF THE INVENTION

Within the context of this task an object of the invention is that of providing varnishing slabs made with materials and surfaces suitable for printing in highly customisable shapes and adaptable to the needs of the customer and the type of varnishing unit.

Another object of the invention is that of making it no longer necessary to use an adhesive interposed between the varnishing layer and the support layer, or alternatively allowing the use of an adhesive with less restrictive adhesive properties: at the moment, the adhesives used must have adhesion properties comprised in a rather restricted adhesion range, to guarantee good manual peeling properties but prevent undesired delamination in the machine, and which represents an important risk factor and additional costs.

Another object of the invention is that of providing economical varnishing slabs with a low environmental impact.

This task and these and other objects are reached by a blanket or slab for overprint varnishing at least comprising a varnishing layer and a single-layer or multilayer support of uniform thickness, wherein the varnishing layer is a non-cross-linked elastomeric thermoplastic polymer, wherein the varnishing layer envisages the presence of non-image areas where no transfer of varnish takes place, wherein the non-image areas are areas of the varnishing layer that lack material and extend from the outer surface of the varnishing layer to a depth which is no less than half the thickness of the varnishing layer, wherein at least one non-image area delineates a geometric shape having an area of less than 5 mm².

Advantageously, the varnishing layer having non-image areas is a physical reproduction of a digital model obtained with additive technology.

The geometric shape of the non-image area with an area of less than 5 mm² can be particularly complex.

In one embodiment, the geometric shape of the non-image area with an area of less than 5 mm² is an irregular polygon.

In one embodiment, the geometric shape of the non-image area with an area of less than 5 mm² is a mixtilinear irregular polygon.

In one embodiment, the geometric shape of the non-image area with an area of less than 5 mm² has at least one curvilinear portion with a radius of curvature that varies.

In a preferred embodiment, the varnishing layer has a thickness comprised between 0.06 mm and 2.00 mm.

In a preferred embodiment, the varnishing layer has an outer surface having a roughness comprised between 0.2 μm and 15.0 μm.

In one embodiment, the non-cross-linked elastomeric thermoplastic polymer is polyurethane-based (TPU).

In one embodiment, the non-cross-linked elastomeric thermoplastic polymer is polyurethane mixed with a silicone polymer.

In one embodiment, the non-cross-linked elastomeric thermoplastic polymer is silicone-based.

In a preferred embodiment, the varnishing layer has localised thickenings which exactly delimit said non-image areas.

In a preferred embodiment, a support layer is made of PET or PVC or PC or PMMA or TPU or metal or fabric made of natural or synthetic fibre.

In a preferred embodiment the support layer is a multilayer where the upper layer, that is to say the end layer facing the varnishing layer, is of the same type of the varnishing layer.

In a preferred embodiment, there is further provided a compressible layer.

In a preferred embodiment, the compressible layer is made of a thermoplastic polyurethane-based material and expanding additives.

In a preferred embodiment, the varnishing layer is free from additives, plasticisers and molecular cross-linking agents.

It is to be noted that although the method of manufacturing flexographic slabs through 3D printing is known (e.g. CN103121323), the technique has always focused on the use of photocross-linkable mixtures of vinyl or acrylovinyl rubber (ABS, SBS, SIS) cross-linked with mono- or diacrylates. The present invention, in some applications, can exploit grades of non-cross-linked thermoplastic polyurethanes without additives, which combine hardness and resistance to impact and abrasion with excellent varnishing properties without the need for complex formulations, or liquid precursors that are potentially harmful to the environment.

The resolution of the deposition of material through 3D printing techniques by the extrusion of elastomeric thermoplastic polymers is comprised between 20 and 100 μm. Unlike flexographic printing where, to guarantee the printing quality, it is appropriate for the resolution to be ≤10 μm, in the application as varnishing layer, it is only required that the edges of the varnishing layer be clear and precise; furthermore, the very low shrinkage percentages (0.8-1.8%) that characterise the thermoplastic polyurethane allow the deposition of shapes with high accuracy, even in the absence of cross-linking or reinforcing agents.

3D printing is intrinsically based on the deposition of successive flat layers, which makes it particularly suitable for manufacturing shapes on flat substrates. However, the surface quality of the deposited material is often worsened by the presence of macroscopic irregularities, especially in the case of filament extrusion. On the contrary, the application of overprint varnishing requires surfaces with particularly controlled roughness. For this reason, the present invention comprises a final surface finishing step for the hot application under pressure of a film of paper or PET or another plastic material with release properties for the transfer of a fine weft of known roughness. The finishing is also possible thanks to the thermoplastic properties of non-cross-linked polyurethane, and confers the desired properties of opacity, slipperiness, prevention of the accumulation of varnishes or inks, surface tension.

### BRIEF DESCRIPTION OF THE DRAWINGS

Further characteristics and advantages of the invention will more fully emerge from the description of a preferred but not exclusive embodiment of a blanket or slab for overprint varnishing, illustrated by way of non-limiting example in the accompanying drawings, in which:

FIG. 1 is a plan view of a blanket or slab for varnishing according to the invention; and

FIG. 2 is a sectional side elevation view, along the line AA, of the blanket or slab for varnishing of FIG. 1.

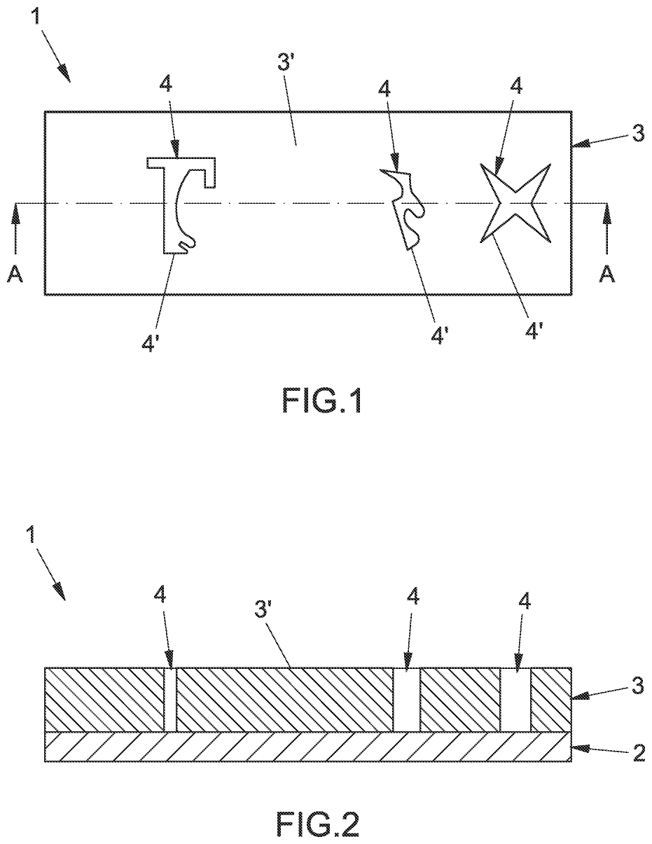

### DETAILED DESCRIPTION OF THE ILLUSTRATED EMBODIMENTS

With particular reference to the above-described figures, the blanket or slab for overprint varnishing according to the present invention is generically indicated by 1.

The blanket or slab for overprint varnishing 1 comprises a support 2 with one or more layers and a varnishing layer 3 made of non-cross-linked thermoplastic polymer for the transfer of an overprint varnish to a printed support.

The varnishing layer 3 has non-image areas 4 where no transfer of varnish takes place.

The non-image areas 4 are areas of the varnishing layer 3 that lack material and extend from the outer surface of the varnishing layer to a depth which is no less than half the thickness of the varnishing layer 3.

In the solution shown, the areas of lack of material pass entirely through the thickness of the varnishing layer 3.

At least one non-image area 4 delineates a geometric shape 4′ having an area of less than 5 mm² and preferably less than 4 mm².

It has been found to be particularly advantageous, for non-image areas 4 of a complex shape and thus a reduced area, for the varnishing layer 3 endowed with such non-image areas 4 to be a physical reproduction of a digital model obtained with additive technology.

The invention has been found to be particularly useful for realising a non-image area of less than 5 mm² formed by an irregular polygon, for example a mixtilinear irregular polygon, or else a geometric figure having at least one curvilinear portion with a radius of curvature that varies.

The realization of the blanket or slab for overprint varnishing 1 thus takes place through the application on the support layer 2 of the non-cross-linked elastomeric thermoplastic polymer with an additive technology that physically reproduces the digital model.

The non-cross-linked elastomeric thermoplastic polymer can be a polyurethane polymer (TPU), a silicone polymer or possibly a mixture thereof.

In particular, the varnishing layer 3 can comprise a polyether-based thermoplastic polyurethane.

The blanket or slab for overprint varnishing 1 has a thickness comprised between 0.8 mm and 4.0 mm.

The support 2 has a thickness comprised between 0.05 mm-0.40 mm and a layer thereof can be made of polymeric material (e.g. PET, PVC, TPU, PC, PMMA) or metal (e.g. aluminium) or natural fibre or synthetic fibre.

There is envisaged the possibility of configuring the support 2 as a multilayer structure with the upper layer thereof of the same type of the varnishing layer to optimise adhesion.

The thermoplastic polyurethane of the varnishing layer 3 adapted for the application of overprint varnish can also be mixed with a silicone polymer.

The varnishing layer 3 preferably has a thickness comprised between 0.06 mm and 2.00 mm.

The support layer 2 and the varnishing layer 3 can be joined through the use of an irreversible adhesive layer made of water- or solvent-based polyurethane or acrylic material.

In particular, it is necessary for the adhesion force between the support 2 and the upper layers to be greater than 7 N/cm, preferably greater than 10 N/cm;

To obtain this result it is possible to use an adhesive, preferably acrylic or polyurethane, with a thickness comprised between 5 μm and 50 μm, preferably between 15 μm and 30 μm.

According to another embodiment of the invention, the support layer 2 and the varnishing layer 3 are joined through a surface treatment of the support layer 2 by means of etching with trichloroacetic acid (TCA).

The blanket or slab for overprint varnishing 1 may further comprise a further compressible layer applicable to a side of the support layer 2.

The compressible layer can be interposed between the varnishing layer 3 and the support layer 2 or alternatively the compressible layer can be applied to the side of the support layer 2 opposite to the one on which the varnishing layer 3 is applied.

The presence of a compressible layer allows the transfer performance of the overprint varnish to be improved.

Preferably, the compressible layer is in turn made of a TPU-based (thermoplastic polyurethane) material and expanding additives.

Both the varnishing layer 3 and any compressible layer may contain organic or inorganic fillers for reaching the optimal rheological properties for the 3D printing step.

The suitable adhesion of the compressible layer to the support layer 2 can be guaranteed through the use of an adhesive or through a surface treatment as described above.

The reproduction precision of the area surrounding the lacking areas is guaranteed by the formation of localised thickenings that exactly delimit the non-print areas.

The thickenings form a collar around the perimeter of the lacking area through the deposition of an additional quantity of the thermoplastic polymer.

Below are some examples of the varnishing blanket or slab.

### Example 1

The varnishing layer 3 is a film of TPU ESTANE™ 58887 deposited through fused deposition modeling (FDM) on the support layer made of PET with TCA treatment with a thickness of 350 μm and then with a surface finish through coupling with a film of PET Transfer release 100 μm thick in a press heated to 150° C. with a pressure of 4 bar, possibly subsequently removed or maintained as the protective layer. The total thickness of the varnishing layer is 1.35 mm, and the varnishing layer has a surface roughness Rₐ=0.900 μm.

### Example 2

The compressible layer 5 is an expanded film of TPU ESTANE™ 54620 having a thickness of 0.500 mm and is obtained through the expansion of the film during the film extrusion process by adding the TPU with 2% Advanced EHM401 and coupled directly during the process to a support layer 2 made of PET having a thickness of 250 μm (Mylar ADS) treated with TCA to increase adhesion. Subsequently, the varnishing layer 3 of TPU based on polyether ESTANE™ 54620 in powder having a thickness of 1.4 mm is deposited on the support layer and sintered with SLS (Selective Laser Sintering) systems. The varnishing layer is subsequently surface finished through coupling with a PET Transfer release film having a thickness of 100 μm in a press heated to 150° C. at a pressure of 1.5 bar. The total thickness of the varnishing layer is 2.15 mm, and the surface roughness of the varnishing layer is Rₐ=0.700 μm.

### Example 3

The varnishing layer 3 is a film of TPU ESTANE™ 58437 deposited through fused filament having a thickness of 2.00 mm (fused deposition modeling, FDM) on the support layer made of TPE Pebax™ with a hardness of 70 Shore D and a thickness of 350 μm and then surface finished through coupling with a FAVINI release paper film having a thickness of 100 μm in a press heated to 150° C. with a pressure of 4 bar, subsequently removed. The total thickness of the varnishing layer is 1.15 mm, and the varnishing layer has a surface roughness Rₐ=0.480 μm.

### Example 4

The varnishing layer 3 is a film of TPU ESTANE™ 54620 deposited through Selective Laser Sintering (SLS) on an aluminium band having a thickness of 300 μm by interposing a layer of hot melt acrylic-based adhesive having a thickness of 30 μm between the aluminium and the TPU. Subsequently, a surface finish is applied on the varnishing layer through treatment under a notched cylinder heated at 150° C. and 4 bar with a sliding speed of 2 m/min. The total thickness of the varnishing layer is 1.35 mm, and the surface roughness is Rₐ=1.2 μm.

The blanket or slab for offset printing varnishing thus conceived is susceptible of numerous modifications and variants, all falling within the scope of the inventive concept; moreover, all of the details can be replaced with technically equivalent elements.

In practice the materials used, as well as the dimensions, can be any according to the needs and the state of the art.

For example, the varnishing layer made of non-cross-linked thermoplastic polymer can also be made of silicone-based material.

What is claimed is:

1. A blanket or slab for overprint varnishing comprising at least a varnishing layer and a single-layer or multilayer support of uniform thickness, wherein the varnishing layer is made of non-cross-linked thermoplastic elastomeric polymer, wherein the varnishing layer envisages the presence of non-image areas where no transfer of varnish takes place, wherein the non-image areas are areas of the varnishing layer that lack material and extend from the outer surface of the varnishing layer to a depth which is no less than half the thickness of the varnishing layer, wherein at least one non-image area delineates a geometric shape having an area of less than 5 mm² and wherein said varnishing layer having non-image areas is a physical reproduction of a digital model obtained with additive technology.

2. The blanket or slab for overprint varnishing according to claim 1, wherein said geometric shape is complex.

3. The blanket or slab for overprint varnishing according to claim 1, wherein the complex geometric shape is an irregular polygon.

4. The blanket or slab for overprint varnishing according to claim 3, wherein the irregular polygon is mixtilinear.

5. The blanket or slab for overprint varnishing according to claim 1, wherein the geometric shape has at least one curvilinear portion with a radius of curvature that varies.

6. The blanket or slab for overprint varnishing according to claim 1, wherein the varnishing layer has a thickness comprised between 0.06 mm and 2.00 mm.

7. The blanket or slab for overprint varnishing according to claim 1, wherein the varnishing layer has an outer surface having a roughness comprised between 0.2 μm and 15.0 μm.

8. The blanket or slab for overprint varnishing according to claim 1, wherein said elastomeric thermoplastic polymer is a polyurethane.

9. The blanket or slab for overprint varnishing according to claim 8, wherein said polyurethane is mixed with a silicone polymer.

10. The blanket or slab for overprint varnishing according to claim 1, wherein said polymer is silicone-based.

11. The blanket or slab for overprint varnishing according to claim 1, wherein said varnishing layer has localized thickenings which exactly delimit said non-image areas.

12. The blanket or slab for overprint varnishing according to claim 1, wherein a support layer is made of PET or PVC or PC or PMMA or TPU or metal or natural or synthetic fibre fabric.

13. The blanket or slab for overprint varnishing according to claim 1, further comprising a compressible layer.

14. The blanket or slab for overprint varnishing according to claim 13, wherein said compressible layer is made of thermoplastic polyurethane-based material and expanding additives.

15. The blanket or slab for overprint varnishing according to claim 1, wherein said varnishing layer is free from additives, plasticisers and molecular cross-linking agents.

16. The blanket or slab for overprint varnishing according to claim 12, wherein said support layer is in turn a multilayer having an end layer facing the varnishing layer of a type same as the varnishing layer.
